(19) United States
(12) Patent Application Publication
(10) Pub. No.: US 2005/0125487 A1
(43) Pub. Date: Jun. 9, 2005

(54) Method and system for distributing contacts within a network

(76) Inventors: Neil O'Connor, Galway (IE); Arik Elberse, Galway (IE); Michael Hartman, Galway (IE)

Correspondence Address: BARNES & THORNBURG, P.O. BOX 2786, CHICAGO, IL, 60690-2786, US

(21) Appl. No.: 10/723,507

(22) Filed: Nov. 26, 2003

(51) Int. Cl. G06F 15/16; G06F 7/00; G06F 17/30

(52) U.S. Cl. 709/201; 709/202; 707/10

(57) ABSTRACT

Contacts received by a contact centre are auctioned to other contact centres to determine an optimum service or cost for each contact. By publishing requests for bids to a network visible space, multiple contact centres or agents can monitor for new requests, and if they can service the request, submit bids to take over the contact at the best price or service level. This enables contacts to be optimally distributed over a network without maintaining centrally records of currently available resources and current statistics for each contact centre. This also adds market competition to the distribution of contacts, providing the potential to increase the overall quality of service and to reduce costs.

### FIELD OF THE INVENTION

The present invention relates to methods and systems for distributing contacts within a network.

### BACKGROUND OF THE INVENTION

Contact centres, such as call centres and multimedia call centres, can operate in a stand-alone capacity or can be part of a distributed contact centre network. When a contact is received at a stand-alone contact centre, it is queued to an agent and dealt with using the resources of the contact centre. However, if the contact centre is connected over a network to other centres, the opportunity arises to pass contacts to other centres (referred to herein also as “nodes”) on the network.

This distribution of contacts to other nodes might be done in order to balance load levels, to use a more suitable agent having a better match of skills to deal with the contact, or to find a contact centre with a shorter queue for the contact in question, to give but a few reasons. It is well known, for example, to determine (using interactive voice response inputs) the preferred language of a caller to a contact centre, and then to transfer that call or contact to a contact centre in another country where there are agents with the necessary language skills. Contacts can be passed over a network either to a contact centre forming part of the same business, or (increasingly commonly nowadays) to a third-party contact centre which has a service agreement with the original contact centre and which handles the contact for a fee.

The mechanisms used to distribute contacts across the network generally involve a centralised contact management application which is provided with status updates from each node and which determines according to a set of predetermined rules which of the available nodes is most suitable to receive the contact. Alternatively, each node can maintain its own set of rules and can make the same determination, based on information available to it from other nodes, when a contact is to be distributed across the network.

The centralised model suffers from the drawback that the distribution of contacts is highly dependent on a single system and is therefore not particularly robust. While the distributed model, where each node makes its own determinations, can be designed to be more robust, it shares a drawback in that the determinations being made are dependent on accurate knowledge of the status of all other nodes, and therefore as the network scales up, the amount of status or event information being passed across the network increases accordingly.

In addition, current contact distribution methods are limited by the rules according to which a determination is made to distribute contacts. Thus, for example, if the most important criterion for sending a contact to a third party node is the cost of servicing the contact, then the third party with the lowest fixed cost will receive most of the transferred contacts, even if another centre is less busy and can deal with the contact more quickly. Of course the rules can be changed to take into account the expected waiting time also, but in general, fixed rules such as this will tend not to optimise the distribution of contacts from the point of view of the referring contact centre.

### SUMMARY OF THE INVENTION

The invention provides a method of distributing a contact across a network having a number of nodes which are equipped to service contacts. The method includes the steps of:
a) generating a contact information entity which is accessible across the network and which comprises information sufficient to enable each node to determine whether it has the resources to service the contact;
b) assessing one or more bids issued by one or more nodes to determine a bid to be used in assigning the contact.
c) on the basis of this determination, assigning the contact to the node which issued said bid.

This method enables contacts to be auctioned by one node to another node to better service the contact. In this way, each contact can be serviced optimally and there is no need to maintain an up to date record of the resources, wait times, etc. of each node.

Furthermore, this method enables a contact source to evaluate the best node for a contact according to any criteria it chooses to specify in the contact information entity. Thus, for certain contacts, the most important criteria might be the cost at which a contact can be serviced. For contacts from customers who are particularly valued, however, the most important criterion might be the wait time to service the customer or the skill levels offered by the winning node. The optimum bid can be determined on the basis of a number of criteria, with factors such as cost, wait times, skill levels etc. being appropriately weighted.

Preferably, each node is a contact centre having a plurality of agents for servicing contacts, each agent having identified skills which enable each contact centre to determine whether it can service a given contact.

The contact information entity is preferably a software object generated in a network accessible space.

The network accessible (or network visible) space is a storage area which some or all resources on a network can access, subject to having any required permissions.

It may be an area on a disk, an area of RAM, or a file accessible from the network, for example.

In a preferred embodiment, the network accessible space is a shared memory space, optionally implemented using JavaSpaces™ technology. Of course, other technologies can also be used to implement a network visible or accessible space.

One particular advantage of using a space visible across the network is that the nodes can appear and disappear without impacting on the operation of the invention. A contact can be placed for auction and the auctioning node simply assesses the bids received. It need not have knowledge of which nodes are currently active and nor need it obtain confirmation from each node that it has placed a bid. This enables contacts to be bid for by a diverse range of nodes including associated contact centres from the same organisation, third party contact centres, and private individuals who may casually log on from time to time to deal with contacts in return for a fee. Of course, security may be implemented to restrict access to the network visible space to only approved nodes or those with whom the appropriate communications protocols or accounting arrangements are in place.

Optionally, the step of generating the contact information entity further includes replicating the entity in a plurality of such shared memory spaces. This helps improve local performance and promotes scalability of the network without draining resources.

As an alternative to an implementation such as a JavaSpaces™ implementation, the contact information entity can be an entry in a database accessible across a network.

In one embodiment, the bids are issued by the nodes and transmitted directly to a resource on the network which is responsible for assessing the one or more bids.

Alternatively, the bids can be issued by the nodes to an area of the network which is accessible by a resource on the network which is responsible for assessing the one or more bids.

Thus, the bids can be written back to the same network visible area into which the contact information was posted and these can then be replicated across other areas so that they become visible to the source of the contact information.

Preferably, the contact information entity identifies at least one skillset required to service the contact.

Further, preferably, the contact information entity identifies at least one parameter according to which bids will be assessed.

Such parameters can be selected from one or more of the following: cost, skillset proficiency, or the time within which the contact is to be serviced. Other parameters will present themselves to the skilled person in particular contexts.

In other embodiments there will be no need to explicitly identify the parameter(s) on which bids are sought, e.g. if it is understood that all bids must specify cost and that only cost is a factor in assessing bids, or if it is understood that for every bid, both cost and time to answer must be specified.

The contact information entity can be a software entity which includes a set of rules according to which a bid score is returned by the contact information entity upon receipt of one or more bid values.

In such cases, the step of assessing one or more bids includes evaluating the bid scores returned by the contact information entity.

The contact information entity can alternatively be a software entity which includes executable logic according to which a bid score is returned by the contact information entity upon receipt of one or more bid values.

Preferably, the executable logic is provided as an object oriented command pattern.

The assessment of bids can be carried out by maintaining a single winning bid, evaluating each new bid as it issues from a node and either discarding the new bid if it is determined to be inferior to the winning bid according to predetermined criteria or substituting it as the new winning bid if it is determined to be better than the previous winning bid.

Thus, for example, a software process can monitor the network visible space into which bids are written and can assess and update the best current bid in real time.

As an alternative, the step of assessing one or more bids can involve collecting all bids which issue within a timeout period and determining which of these bids is to be used in assigning the contact.

Rather than being contact centres, one or more nodes may be the computer of a user connected to the network, whereby said user may make a determination as to whether he or she has the skills to service said contact and as to whether or not to issue a bid. In this way, freelance agents can access and bid for contacts in competition with one another or with contact centres.

The invention also provides a method of obtaining contacts across a network from a contact source. This method involves the steps of:
a) receiving via the network contact information which comprises information sufficient to enable a node to determine whether it has the resources to service the contact;
b) issuing a bid to the contact source offering to service the contact based on said information; and
c) in the event that the bid is successful, receiving the contact from the contact source.

This method enables nodes to tailor the criteria (such as price) according to which they will service contacts based on the resources available to them at any time.

Perhaps more importantly, rather than having a fixed price for a particular contact type, each node can adjust its prices to take account of market forces. Such an element of competition is very likely to result in increased efficiencies and to improve service. Of course, cost may not be the determining factor. If a number of nodes compete for contacts and the auctioning node receives feedback from customers that the quality of agents is poor, then the relative importance of skill proficiencies in the bid assessment process can be increased and this will be felt within the market as a pressure to drive up the importance of training. Similarly, any node which has lengthy call waiting times can expect to see its market share drop if call waiting times are important to the customer, as this will lead to such a parameter having increased weighting.

This highlights an important feature of the invention, namely the improvements which can be expected by auctioning contacts rather than assigning them according to fixed price lists or set rules. Whichever criteria are important according to market forces will be maximised by the bidding nodes, and thus the quality of the overall service can be expected to improve.

In another aspect the invention provides a method of distributing contacts across a network having a plurality of connected contact centres, comprising the steps of:
a) upon receipt of a contact by a contact centre, publishing information relating to the contact over the network;
b) awaiting one or more bids from remote contact centres offering to service the contact;
c) determining from said bids a destination for the contact; and
d) forwarding the contact to said destination.

Preferably, the contact information entity is a JavaSpace entry and the step of receiving the contact information comprises reading said entries from a JavaSpace.

In one embodiment, the step of issuing a bid comprises modifying said entry and writing the modified entry in a JavaSpace.

Alternatively, the step of issuing a bid may comprise generating a new entry including a reference which relates the new entry to the original contact information entity, and writing the new entry to a JavaSpace.

The destination mentioned above may be a remote contact centre which issued one or more of said bids, or it may be a local contact queue of the contact centre which received the contact.

The invention also provides an apparatus for distributing a contact across a network having a number of nodes which are equipped to service contacts, comprising:
a) a contact information generator for generating a contact information entity which is accessible across the network and which comprises information sufficient to enable each node to determine whether it has the resources to service the contact;
b) a bid assessment module for assessing one or more bids issued by one or more nodes to determine a bid to be used in assigning the contact; and
c) contact assignment means for, on the basis of said determination, assigning said contact to the node which issued said bid.

The invention further provides an apparatus for obtaining contacts across a network from a contact source, comprising:
a) a network connection for receiving via the network contact information;
b) an evaluation module for evaluating said contact information to determine whether a node associated with said apparatus has the resources to service the contact; and
c) a bid generation unit for issuing a bid to the contact source offering to service the contact based on said information.

In another aspect there is provided a contact centre comprising:
a) a network connection for distributing contacts to one or more other contact centres;
b) a contact manager for controlling contacts received at the contact centre from one or more communications networks;
c) a contact information generator for generating a contact information entity which is accessible across the network and which comprises information sufficient to enable each node to determine whether it has the resources to service a contact;
d) a bid assessment module for assessing one or more bids issued by one or more nodes to determine a bid to be used in assigning the contact; and
e) contact assignment means for, on the basis of said determination, assigning said contact to the node which issued said bid.

The invention also encompasses a network having a plurality of connected contact centres, wherein at least one of said contact centres includes:
a) a network connection for distributing contacts to one or more other contact centres;
b) a contact manager for controlling contacts received at the contact centre from one or more communications networks;
c) a contact information generator for generating a contact information entity which is accessible across the network and which comprises information sufficient to enable each node to determine whether it has the resources to service a contact;
d) a bid assessment module for assessing one or more bids issued by one or more nodes to determine a bid to be used in assigning the contact; and
e) contact assignment means for, on the basis of said determination, assigning said contact to the node which issued said bid.

In another aspect there is provided a computer program product in machine readable form comprising instructions in machine readable form which when executed by a computer associated with a contact centre are effective to cause said computer to:
a) generate a contact information entity which is visible across the network and which comprises information sufficient to enable each node to determine whether it has the resources to service the contact;
b) assess one or more bids issued by one or more nodes to determine a bid to be used in assigning the contact; and
c) on the basis of said determination, assign said contact to the node which issued said bid.

A further computer program product is provided, according to another aspect of the invention, in machine readable form comprising instructions in machine readable form which when executed by a computer associated with a contact centre are effective to cause said computer to:
a) receive via the network contact information which comprises information sufficient to enable a node to determine whether it has the resources to service the contact;
b) issue a bid to the contact source offering to service the contact based on said information; and
c) in the event that the bid is successful, receive the contact from the contact source.

The invention also provides a computer software object encoding contact information and comprising:
a) information identifying a node which controls the contact;
b) information identifying one or more characteristics of the contact; and
c) information identifying one or more parameters for which bids are sought by said node, such that a different node may bid to have control of the contact transferred to it.

### BRIEF DESCRIPTION OF DRAWINGS

The invention will now be illustrated by the following descriptions of embodiments thereof given by way of example only with reference to the accompanying drawings, in which:

FIG. 1 is a block diagram architecture of a contact centre according to the invention;

FIG. 2 is an architecture of a network according to the invention;

FIG. 3 is a flowchart illustrating a method of the invention carried out by a node distributing a contact;

FIG. 4 is a flowchart illustrating a method of the invention carried out by a node bidding for a contact;

FIG. 5 is a flowchart illustrating a method of the invention carried out by a winning node following a successful bid for a contact.

### DETAILED DESCRIPTION OF PREFERRED EMBODIMENTS

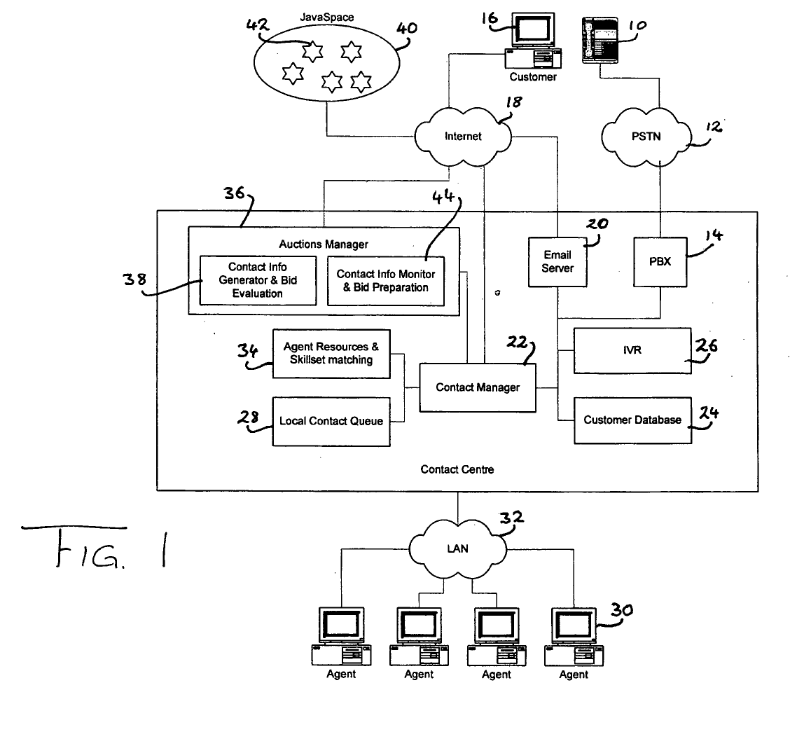

FIG. 1 shows the architecture of a multimedia contact centre which is adapted to receive and process contacts from outside parties such as customers of an organisation. The contacts may be emails, text messages, phone calls, video calls, internet chat sessions or any other type of communications. For simplicity, the contact centre is shown with the capacity for dealing with two types of contacts, namely voice calls which are received from a customer's phone 10 via the public switched telephone network (PSTN) 12 and a private branch exchange (PBX) 14, and emails received from a customer's PC 16 via the Internet 18 and an email server 20, both in conventional fashion. Of course the phone calls may be made via the Internet or wirelessly, and the emails could be received over a wide area network or local area network, and numerous other methods of communication between a customer and a contact centre will readily present themselves to the skilled person.

When a contact is received at the email server or the PBX, a contact manager 22 is notified (the contact manager will typically be implemented in a piece of software or firmware which when executed carries out the functions described herein). The contact manager will typically then obtain information to enable the contact to be directed to an agent equipped to handle the contact. Taking the example of a phone call received at PBX 14, this can be done by looking up the calling line ID in a customer database 24 (to determine if it is an existing customer with a predefined service level or skillset with an ongoing contact history which enables the contact to be categorised), and by directing the call to an interactive voice response (IVR) unit 26 which obtains further information about the nature and origin of the contact via keypresses or voice responses made by the customer to navigate a menu.

Conventionally, the contact is then placed in a local contact queue 28 (if it cannot be assigned immediately to an agent) and then is directed to an agent 30 connected over a local area network 32 when a suitable agent becomes available (as determined by an agent resources and skillset matching function 34.

Conventionally also, the contact can be directed to another contact centre by matching the contact with a network wide list of agent resources maintained by a network manager (not present in this embodiment). The illustrated embodiment however, enables the contact to be assigned to a remote resource in a different manner as will now be described.

When a contact is received and the skillset and customer ID (if available) is determined, the contact manager can place the contact for “auction” over a network of contact centres and agents (referred to collectively as nodes).

As a first step, the contact details are passed to an auctions manager 36 which includes a contact information and bid evaluation function 38. This module prepares a contact information software object. One implementation of this uses the JavaSpaces technology (JavaSpaces is a trade mark of Sun Microsystems).

A JavaSpace is a network visible memory area into which objects (known as entries) can be written and from which they can be read or taken (i.e. read and deleted). A number of different computers will typically have access to a JavaSpace, and each can (subject to security and permissions) read and write entries into this single space. Operations (such as read, write and take) are atomic, i.e. they occur in a single transaction and occur one at a time, so that a JavaSpace is a useful way of sharing synchronised state information across a network without two resources changing the same entry in different ways. In JavaSpaces technology, different processes on different machines do not interact with one another but instead each interact with the JavaSpace. The processes are therefore uncoupled and this allows processes to appear and disappear without affecting the rest of the network. Usually, objects written into a space have a limited lifetime, so that when a resource disappears from the network, its objects also disappear shortly afterwards, and in this way, the network is self healing.

A JavaSpace 40 is shown connected to the Internet 18 and in this space, a number of entries 42 are schematically represented. The contact info generator 38 writes an entry 40 containing contact information sufficient to identify the resources required to properly handle the contact (such as identification of language and technical competencies required and an indication of the customer category, if relevant) and also specifying a number of bid parameters sought. Bids are received from other nodes having access to the JavaSpace (as will be more fully described below) and these are evaluated by the contact info and bid evaluation module to determine an optimum bid based on e.g. pricing information, service level promises and skillset competencies, and the contact is then distributed to the winning node by the contact manager 22.

Depending on preference, the contact manager can place every contact received for auction, or can auction only contacts for which it does not have the available resources to handle locally. In the event that all contacts are placed for auction, the bids can be compared with the cost, service level and competency which are locally available from the contact centre's own resources, and then decide whether to send the contact to a remote node or handle it locally.

The contact centre may itself want to bid for contacts available from remote nodes, which is accomplished by a contact info monitor and bid preparation module 44. This module monitors the JavaSpace 42 for new entries describing contacts for auction from remote nodes, and then evaluates such contact information entries to determine whether they can be serviced, and if so, at what cost, service level and skillset proficiency (assuming again that these are the parameters on which bids are sought). This module then prepares bids and sends these to the remote auctioning node in an attempt to win the contacts. This module may also then monitor contacts received from remote nodes in order to match them against the winning bids and ensure that the incoming contacts are serviced as promised in the relevant bid.

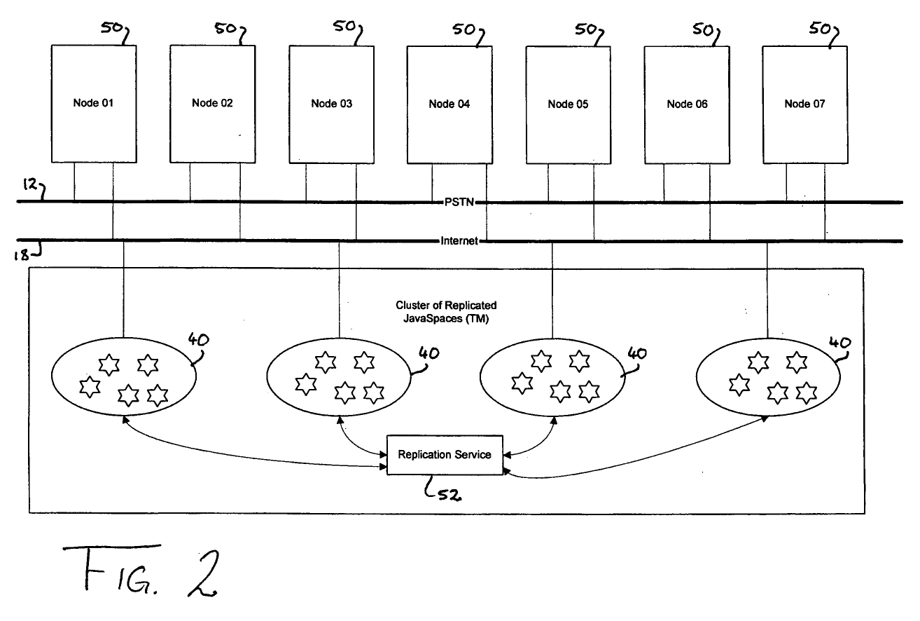

FIG. 2 shows the overall architecture of a contact centre network. A number of nodes 50, which may be contact centres (as described in relation to FIG. 1) or independent agents having software embodying the auctions manager and communications facilities to receive and process contacts referred by contact centres, are connected to the PSTN 12 and Internet 18. Using these two communications networks, calls can be transferred from one node to another in any known manner, and emails and other communications can similarly be forwarded or transferred.

A number of JavaSpaces 40 are also connected to the Internet and visible to each of the nodes. These JavaSpaces form a cluster and a software replication service 52 monitors each JavaSpace and replicates all entries in the space to each other space. (It is also possible to set rules as to whether or not to replicate entries but this is not particularly relevant to this invention.) Each node will typically access, via the Internet, a node close to it in order to maximise connection speeds. Indeed, each node may host its own JavaSpace. If suited to the environment in which the nodes operate, the cluster can be replaced by a single JavaSpace.

The basic operations of read, write and take have been outlined above. In addition, it is possible to use a notify operation in which a process monitors the space for an entry matching certain criteria and then notifies the requesting resource if and when this appears. Using these four operations, the functionality of the present embodiment can be implemented using this technology.

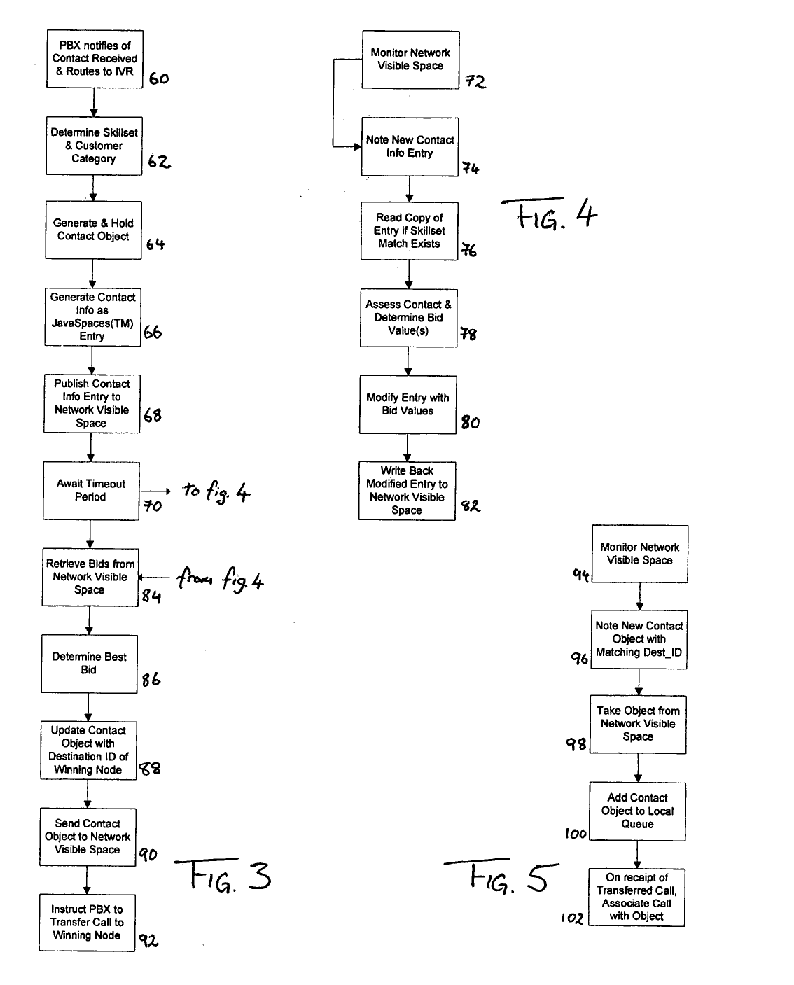

Referring additionally to FIG. 3, a flowchart is shown illustrating the process operating in the auctioning node, using the example of a voice call received at the node which is to be auctioned off to other nodes in order to reduce cost or obtain better service for the customer.

The contact manager 22 is notified of the contact, step 60, following which the contact's characteristics (skillset, customer ID, etc.) are determined from IVR and database lookups, or in any other suitable manner, step 62. The contact manager then generates a contact object, step 64 defining the contact (at this point the physical call will be held by the PBX pending instructions to forward the call to an agent or a remote node). The contact details are passed to the auctions manager 36, where the contact info generator instantiates an entry in a JavaSpace and writes the values required for such an entry. Typically, these might include the auctioning node ID, the skillset identifiers which define the skills needed to handle a contact, and any minimum service level requirements. The entry might also include blank values for parameters such as price, time to answer, and skillset proficiency(ies), whereby it indicates that these parameters are the values on which bids are to be evaluated. By writing this entry into one JavaSpace, step 68, it is made visible by the replication service 52 in each of the other JavaSpaces. The auctions manager 36 then awaits a timeout period, step 70.

Referring now to FIG. 4, the process is taken up by the other nodes on the network. Each node will typically have a notify operation running in a JavaSpace 40 requesting that it be alerted either to all new contact information entries, or to all entries matching the contact types which it can service. Notify processes are implemented by defining a template entry which is structured identically to the entry type to be retrieved (and thus it will have the format, in this instance, of a contact information entry), in which the fields to be matched are filled in (such as specifying skillset French, if all French contacts are to be retrieved) and leaving blank the fields which are to be wildcard matched (e.g. if all contacts are to be retrieved, irrespective of language, then the notify template would simply not have any value in the space where the language skillset is defined).

In this manner the network space is monitored by a remote node for new contact information entries, indicating contacts up for auction, step 72. When the notify process sees a new entry, step 74, it carries out its matching function to see if the entry meets the criteria specified by the node, such as if a skillset match exists, and if so the read operation is invoked to make a copy of the entry and return this copy to the contact info monitor and bid preparation module 44 of the remote (bidding) node, step 76. As indicated above the matching part of this step can be omitted and all contact information entries can simply be returned for further evaluation at the node.

Module 44 reviews the information supplied in the entry to arrive at values for the parameters on which bids are requested, step 78. The complexity of this function is left to the designer of the software and can be as straightforward or as sophisticated as desired. For example, the time to answer can simply be derived from the current time to answer statistic typically maintained by contact centres for performance and statistical monitoring. Alternatively, it can be adjusted to increase the prospects of winning the auction. There can also be a trade off between this and other bid parameters. For example, if experience has shown that Node 04 tends to award contacts to nodes which answer quickly, even if the price is higher, then the time to answer might be reduced and the price increased, to maximise the prospects of winning the contact. Of course, it would then be necessary, upon receipt of the contact, to prioritise the answering of the call in order to meet the obligations imposed by the winning bid.

As an aside, nodes can be provided with feedback as to the individual parameter values of winning bids, or of aggregate values (such as that the average winning bid cost in the previous 15 minute period was 83 cents) in order that they can better tailor their bids to the market's values. Whether or not to provide feedback, and the level of feedback will depend, among other things, on whether auctions are collaborative (such as among commonly owned contact centres where the priority is to provide the best available service at the lowest cost) or competitive (where the different bidding nodes are competitors who might not agree to their winning bids being published); on whether there is perceived value for money in allocating resources to providing feedback, and on commercial confidentiality between the parties involved.

The bidding node then modifies its copy of the contact information entry with its bid values and its own node ID, step 80, and writes this modified copy back to the network visible space, step 82 where it is replicated to other spaces and thus becomes visible to the auctioning node. The bids (modified contact information entries) may be visible to all nodes, or may be modified such that only the auctioning node has read permission for the bids. As an alternative, bid values could simply be transmitted as new messages for collection by the auctioning node, or could be sent using some other messaging protocol. If the JavaSpaces implementation was replaced by e.g. a network visible database, then the bidding nodes could update this database with their own bid values for each new contact information record appearing.

Rather than modifying the entries to create bids, the bidding node(s) can read the contact information entry and then create a new bid entry with a different format. The bid entry can be associated with the contact information entry by a common ID field, such as the identifier of the contact which is being auctioned.

Reverting back to FIG. 3, at the end of the timeout period the auctioning node will read or take from the JavaSpace all of the bid entries (i.e. modified copies of its original contact information entry) and will then compare these bids to determine an optimum bid, according to its own criteria as to what constitutes the best bid, step 86. Again, this can be as simple or as sophisticated as desired by the auctioning node.

Again as an alternative, the implementation can include a process which monitors the space throughout the timeout period and reviews each bid as it appears, wither maintaining it if it is the only or current best bid, and discarding it if it is determined to be worse than the current best bid. In this scenario, there would only be a single bid (or no bids at all) at the end of the timeout period. Similarly, in a database implementation, a process might continually filter new records representing bids worse than the current best bid so that only a single bid remains at any time.

When the best bid is determined, the contact object itself (not the contact information entry) is updated with the destination ID of the winning node, step 88, and this contact object is then written to the JavaSpace, step 90 as a notification to the winning node to take control of the contact. The PBX is then instructed by the contact manager, step 92, to transfer the physical call to the winning node. (In the case of an email or other communication, similar steps would apply for the transfer of the email, chat session, or other communication).

Referring to FIG. 5, each bidding node will have a notify process in place monitoring the space for new contact objects as opposed to contact information entries, step 94. This notify process will only make a match with contact objects which have that node's destination ID, step 96, in which case the object is taken from the space, step 98, and added to the local contact queue, step 100. In effect, when the notify process notes a new contact object with the specified ID this is an indication that it has won the auction and that the physical contact represented by the contact object is being transferred. The PBX of the winning node, on receipt of the transferred call, will notify its contact manager of the new call, and the contact manager will then associate this call, step 102, with the contact object placed in the local queue in step 100. The call will then be transferred to an agent in the normal manner, taking care to adhere to any “promises” made in the winning bid.

Each node can run accounting functions, which are peripheral to this invention, to ensure that any monetary sums due as a result of the auction process are correctly paid. Furthermore, quality control measures, such as the ability to listen in to transferred calls or to view statistical data associated with transferred contacts, can be put in place so that the auctioning node can be satisfied as to the quality of service provided by the bidding nodes.

It should be noted that the auctioning process need not always be concerned with merely economic factors. In a collaborative environment of associated call centres, this process might be used as a means of identifying the highest current quality of service for important customers, or of locating across the network a scarce skillset, without having to maintain centrally a list of agents currently available with each skillset.

Also it should be noted that there is no necessity to accept any bid, and thus this process can be used as part of the decision making process by a contact centre as to which agent should service a contact, with the contact being transferred externally only when the bid is too good to refuse. Similarly, the winning contact centre need not necessarily service the contact itself. It might be possible for the winning centre to re-auction the contact (subject to the contact being serviced as agreed in the winning bid) over another network of contact centres, giving rise to arbitrage opportunities or to contact brokers who buy and sell contacts without ever servicing them themselves, surviving from the profits available between different contact centre networks.

The invention is not limited to the embodiments described herein which may be varied or modified without departing from the spirit and scope of the claimed invention.

1. A method of distributing a contact across a network having a number of nodes which are equipped to service contacts, comprising the steps of:
a) generating a contact information entity which is accessible across the network and which comprises information sufficient to enable each node to determine whether it has the resources to service the contact;
b) assessing one or more bids issued by one or more nodes to determine a bid to be used in assigning the contact; and
c) on the basis of said determination, assigning said contact to the node which issued said bid.

2. A method as claimed in claim 1, wherein one or more of said nodes is a contact centre having a plurality of agents for servicing contacts, each agent having identified skills which enable each contact centre to determine whether it can service a given contact.

3. A method as claimed in claim 1, wherein said contact information entity is a software object generated in a network accessible space.

4. A method as claimed in claim 3, wherein said network accessible space is a shared memory space, optionally implemented using JavaSpaces™ technology.

5. A method as claimed in claim 3, wherein the step of generating said contact information entity further comprises replicating said object in a plurality of said shared memory spaces.

6. A method as claimed in claim 1, wherein said contact information entity is an entry in a database accessible across a network.

7. A method as claimed in claim 1, wherein said bids are issued by the nodes and transmitted directly to a resource on the network which is responsible for assessing the one or more bids.

8. A method as claimed in claim 1, wherein said bids are issued by the nodes to an area of the network which is accessible by a resource on the network which is responsible for assessing the one or more bids.

9. A method as claimed in claim 1, wherein said contact information entity identifies at least one skillset required to service the contact.

10. A method as claimed in claim 1, wherein said contact information entity identifies at least one parameter according to which bids will be assessed.

11. A method as claimed in claim 10, wherein said at least one parameter is selected from a cost metric, a skillset proficiency metric, and a metric identifying the time within which the contact is to be serviced.

12. A method as claimed in claim 1, wherein said contact information entity is a software entity which includes a set of rules according to which a bid score is returned by the contact information entity upon receipt of one or more bid values.

13. A method as claimed in claim 12, wherein said step of assessing one or more bids comprises evaluating the bid scores returned by the contact information entity.

14. A method as claimed in claim 1, wherein said contact information entity is a software entity which includes executable logic according to which a bid score is returned by the contact information entity upon receipt of one or more bid values.

15. A method as claimed in claim 14, wherein the executable logic is provided as an object oriented command pattern.

16. A method as claimed in claim 1, wherein said step of assessing one or more bids comprises maintaining a single winning bid, evaluating each new bid as it issues from a node and either discarding the new bid if it is determined to be inferior to the winning bid according to predetermined criteria or substituting it as the new winning bid if it is determined to be better than the previous winning bid.

17. A method as claimed in claim 16, wherein said step of assessing one or more bids comprises collecting all bids which issue within a timeout period and determining which of these bids is to be used in assigning the contact.

18. A method as claimed in claim 1, wherein one or more of said nodes is a computer of a user connected to the network, whereby said user may make a determination as to whether he or she has the skills to service said contact and as to whether or not to issue a bid.

19. A method of obtaining contacts across a network from a contact source, comprising the steps of:
a) receiving via the network contact information which comprises information sufficient to enable a node to determine whether it has the resources to service the contact;
b) issuing a bid to the contact source offering to service the contact based on said information; and
c) in the event that the bid is successful, receiving the contact from the contact source.

20. A method as claimed in claim 19, wherein said contact information is provided in a software object generated in a network accessible space.

21. A method as claimed in claim 19, wherein said network accessible space is a shared memory space, optionally implemented using JavaSpaces™ technology.

22. A method as claimed in claim 20, wherein the step of generating said contact information entity further comprises replicating said object in a plurality of said shared memory spaces.

23. A method as claimed in claim 22, wherein said contact information entity is a JavaSpace entry and the step of receiving the contact information comprises reading said entries from a JavaSpace.

24. A method as claimed in claim 23, wherein the step of issuing a bid comprises modifying said entry and writing the modified entry in a JavaSpace.

25. A method as claimed in claim 23, wherein the step of issuing a bid comprises generating a new entry including a reference which relates the new entry to the original contact information entity, and writing the new entry to a JavaSpace.

26. A method as claimed in claim 19, wherein said contact information entity is an entry in a database accessible across a network.

27. A method as claimed in claim 19, wherein said bid is issued by the node and transmitted directly to a resource on the network which is responsible for assessing the one or more bids.

28. A method as claimed in claim 19, wherein said bid is issued by the node to an area of the network which is accessible by a resource on the network which is responsible for assessing the one or more bids.

29. A method as claimed in claim 19, wherein said contact information identifies at least one skillset required to service the contact.

30. A method as claimed in claim 19, wherein said contact information identifies at least one parameter according to which bids will be assessed.

31. A method as claimed in claim 30, wherein said at least one parameter is selected from a cost metric, a skillset proficiency metric, and a metric identifying the time within which the contact is to be serviced.

32. A method as claimed in claim 19, wherein said contact information is provided in a software entity which includes a set of rules according to which a bid score is returned by the software entity upon receipt of one or more bid values.

33. A method as claimed in claim 19, wherein said contact information entity is a software entity which includes executable logic according to which a bid score is returned by the contact information entity upon receipt of one or more bid values.

34. A method of distributing contacts across a network having a plurality of connected contact centres, comprising the steps of:
a) upon receipt of a contact by a contact centre, publishing information relating to the contact over the network;
b) awaiting one or more bids from remote contact centres offering to service the contact;
c) determining from said bids a destination for the contact; and
d) forwarding the contact to said destination.

35. A method as claimed in claim 34, wherein said destination is a remote contact centre which issued one or more of said bids.

36. A method as claimed in claim 34, wherein said destination is a local contact queue of the contact centre which received the contact.

37. An apparatus for distributing a contact across a network having a number of nodes which are equipped to service contacts, comprising:
a) a contact information generator for generating a contact information entity which is accessible across the network and which comprises information sufficient to enable each node to determine whether it has the resources to service the contact;
b) a bid assessment module for assessing one or more bids issued by one or more nodes to determine a bid to be used in assigning the contact; and
c) contact assignment means for, on the basis of said determination, assigning said contact to the node which issued said bid.

38. An apparatus for obtaining contacts across a network from a contact source, comprising:
a) a network connection for receiving via the network contact information;
b) an evaluation module for evaluating said contact information to determine whether a node associated with said apparatus has the resources to service the contact; and
c) a bid generation unit for issuing a bid to the contact source offering to service the contact based on said information.

39. A contact centre comprising:
a) a network connection for distributing contacts to one or more other contact centres;
b) a contact manager for controlling contacts received at the contact centre from one or more communications networks;
c) a contact information generator for generating a contact information entity which is accessible across the network and which comprises information sufficient to enable each node to determine whether it has the resources to service a contact;
d) a bid assessment module for assessing one or more bids issued by one or more nodes to determine a bid to be used in assigning the contact; and
e) contact assignment means for, on the basis of said determination, assigning said contact to the node which issued said bid.

40. A network having a plurality of connected contact centres, wherein at least one of said contact centres comprises:
a) a network connection for distributing contacts to one or more other contact centres;
b) a contact manager for controlling contacts received at the contact centre from one or more communications networks;
c) a contact information generator for generating a contact information entity which is accessible across the network and which comprises information sufficient to enable each node to determine whether it has the resources to service a contact;
d) a bid assessment module for assessing one or more bids issued by one or more nodes to determine a bid to be used in assigning the contact; and
e) contact assignment means for, on the basis of said determination, assigning said contact to the node which issued said bid.

41. A computer program product comprising instructions in machine readable form which when executed by a computer associated with a contact centre are effective to cause said computer to:
a) generate a contact information entity which is accessible across the network and which comprises information sufficient to enable each node to determine whether it has the resources to service the contact;
b) assess one or more bids issued by one or more nodes to determine a bid to be used in assigning the contact; and
c) on the basis of said determination, assign said contact to the node which issued said bid.

42. A computer program product comprising instructions in machine readable form which when executed by a computer associated with a contact centre are effective to cause said computer to:
a) receive via the network contact information which comprises information sufficient to enable a node to determine whether it has the resources to service the contact;
b) issue a bid to the contact source offering to service the contact based on said information; and
c) in the event that the bid is successful, receive the contact from the contact source.

43. A computer software object encoding contact information and comprising:
a) information identifying a node which controls the contact;
b) information identifying one or more characteristics of the contact; and
c) information identifying one or more parameters for which bids are sought by said node, such that a different node may bid to have control of the contact transferred to it.
